(19) United States
(12) Patent Application Publication
(10) Pub. No.: US 2024/0303068 A1
(43) Pub. Date: Sep. 12, 2024

(54) METHOD FOR MANAGING A MEMORY AREA OF A MOTOR-VEHICLE ELECTRONIC CONTROL UNIT

(71) Applicant: Continental Automotive Technologies GmbH, Hannover (DE)

(72) Inventors: Cyril Da Rosa Pereira, Toulouse (FR); Romain Peyras Loustalet, Toulouse (FR)

(21) Appl. No.: 18/575,026

(22) PCT Filed: Jul. 4, 2022
(86) PCT No.: PCT/EP2022/068406

§ 371 Date: Dec. 28, 2023

(30) Foreign Application Priority Data
Jul. 8, 2021 (FR) 2107399

(51) Int. Cl. G06F 8/65; G06F 9/445

(52) U.S. Cl. CPC G06F 8/65; G06F 9/445

(57) ABSTRACT

A method for managing a memory area of an electronic control unit of a motor vehicle. The method including implementing a first set of control instructions by the bootloader module so that the current hardware configuration of the electronic control unit is identical to the requested hardware configuration for installing the application update; resetting the bootloader module; checking the hardware configuration requested by the application update; and, when the configuration requested by the application update is identical to the current hardware configuration of the electronic control unit, installing the application update.

### CROSS REFERENCE TO RELATED APPLICATIONS

This application is the U.S. National Phase Application of PCT International Application No. PCT/EP2022/068406, filed Jul. 4, 2022, which claims priority to French Patent Application No. 2107399, filed Jul. 8, 2021, the contents of such applications being incorporated by reference herein.

### FIELD OF THE INVENTION

The present invention relates to the automotive field and more specifically to a method for managing a memory area of an electronic control unit of a motor vehicle.

### BACKGROUND OF THE INVENTION

Nowadays, motor vehicles implement various electronic control units (ECUs) to control certain on-board electrical or electronic equipment. For example, it is known for one or more electronic control units to be used to control the one or more engines of the vehicle or even the on-board electronic equipment of the vehicle.

In a known manner, an electronic control unit comprises a microcontroller associated with a memory area, in which instructions forming a computer application are stored. These instructions allow the electronic control unit to control the various items of equipment by generating and sending commands to them.

In an existing embodiment of the architecture, the electronic control unit comprises a bootloader module, implemented by the microcontroller, hardware registers and an application stored in the memory area and dedicated to the operation of the electronic control unit. The bootloader module, which is known to a person skilled in the art as a “bootloader”, can be activated remotely from a computer via a software maintenance tool and allows the manufacturer or a maintenance operator to install and update the application. The hardware registers define the operation of the electronic control unit and can be configured in various positions, with the configuration of all these registers defining the hardware configuration of the electronic control unit.

In an existing solution, a distinction is made between an initial installation mode of the application and a mode for updating an application already installed in the memory area of the electronic control unit. In the initial installation mode, the bootloader module first receives an installation request from the software maintenance tool and installs the application directly. In the update mode, the bootloader module initially receives an update request from the software maintenance tool, deletes the application that is already installed, checks that the hardware configuration requested by the new application so as to operate it complies with the hardware configuration of the microcontroller and then, when the requested configuration is compliant, proceeds to install or update the application.

However, a problem arises when the configuration requested by the application update is different from the hardware configuration used by the electronic control unit at the time of said update. Indeed, since the configuration requested by the application is not checked by the bootloader module during the initial installation of the application, it is possible that the application is installed and running even though the configuration it requests is different from the hardware configuration of the electronic control unit. In this case, it transpires that, since the configuration requested by the update is different from the hardware configuration of the electronic control unit, the bootloader module will not only be unable to install the update, but the electronic control unit will become unusable because the bootloader module will have deleted the application from the memory area following the update request.

Therefore, a requirement exists for a solution for at least partly addressing these disadvantages.

### SUMMARY OF THE INVENTION

One of the aims of an aspect of the invention is to allow updating of an application installed in the memory area of an electronic control unit with a configuration different from the hardware configuration of said electronic control unit. Another aim of an aspect of the invention is to allow continued use of an electronic control unit irrespective of the configuration requested by the update of an application that is already installed.

To this end, the first aim of an aspect of the invention is a method for managing a memory area of an electronic control unit of a motor vehicle, said electronic control unit comprising a microcontroller, a plurality of hardware registers and a memory area, said microcontroller being configured to receive, from an external software maintenance tool, a request to update an application installed in a space of the memory area with a target application and to execute the instructions contained in a bootloader module implemented by said microcontroller and the instructions of the application contained in the space of the memory area, with the hardware registers being adapted to be placed in various positions defining the current hardware configuration of the electronic control unit, said method comprising the steps of:
receiving a first request for updating the installed application from a first set of control instructions, with said first set of control instructions being configured to be implemented with the current hardware configuration of the electronic control unit;
implementing the first set of control instructions by the bootloader module following the reception of said first request, with the first set of control instructions being configured to modify the current hardware configuration of the electronic control unit so as to make it identical to the requested hardware configuration for installing the update of the installed application;
invalidating the first set of control instructions;
resetting the bootloader module;
receiving a second request for updating the installed application from a second set of control instructions, with said second set of control instructions being configured to be implemented with the modified hardware configuration of the electronic control unit;
implementing the second set of control instructions by the bootloader module following the reception of said second request, with the second set of control instructions being configured to check that the hardware configuration requested by the application update is identical to the modified hardware configuration of the electronic control unit and to validate the update of the application in order to implement it during the next boot.

The method according to an aspect of the invention allows the hardware configuration of the electronic control unit to be updated in order to ensure that it corresponds to the requested hardware configuration for installing the application update (i.e., installing the target application) correctly. Notably, the current hardware configuration of the electronic control unit can be corrected, thus avoiding physically replacing the electronic control unit.

Preferably, with the first set of control instructions comprising a command library configured to modify the hardware registers, said library is implemented when the first set of control instructions is executed.

Even more preferably, with the second set of control instructions allowing the first set of control instructions to be deleted, the method comprises a step of deleting the first set of control instructions.

According to one aspect of the invention, invalidating the first set of control instructions involves reactivating the bootloader module so that said bootloader module completes the update of the application.

An aspect of the invention also relates to a computer program product that is noteworthy in that it contains a set of program code instructions that, when they are executed by one or more microcontrollers or processors, configure the one or more microcontrollers or processors to implement a method as described above.

An aspect of the invention also relates to an electronic control unit for a motor vehicle, said electronic control unit comprising a microcontroller, a plurality of hardware registers and a memory area, said microcontroller being configured to receive, from an external software maintenance tool, a request to update an application installed in a space of the memory area with a target application and to execute the instructions contained in a bootloader module implemented by said microcontroller and the instructions of the application contained in the space of the memory area, with the hardware registers being adapted to be placed in various positions defining the hardware configuration of the electronic control unit, the electronic control unit being configured for:
receiving a first request for updating the installed application from a first set of control instructions, with said first set of control instructions being configured to be implemented with the current hardware configuration of the electronic control unit;
implementing the first set of control instructions by the bootloader module following the reception of said first request, with the first set of control instructions being configured to modify the current hardware configuration of the electronic control unit so as to make it identical to the requested hardware configuration for installing the update of the installed application;
invalidating the first set of control instructions;
resetting the bootloader module;
receiving a second request for updating the installed application from a second set of control instructions, with said second set of control instructions being configured to be implemented with the modified hardware configuration of the electronic control unit;
implementing the second set of control instructions by the bootloader module following the reception of said second request, with the second set of control instructions being configured to check that the hardware configuration requested by the application update is identical to the modified hardware configuration of the electronic control unit and to validate the update of the application in order to implement it during the next boot.

Preferably, with the first set of control instructions further comprising a library of commands configured to modify the hardware registers, the microcontroller is configured to implement said library when executing the first set of control instructions.

Even more preferably, since the second set of control instructions allows the first set of control instructions to be deleted, the microcontroller is configured to control the deletion of the first set of control instructions.

According to one aspect of the invention, the microcontroller is configured to invalidate the first set of control instructions, preferably by reactivating the bootloader module so that said bootloader module completes the update of the application.

An aspect of the invention also relates to a motor vehicle comprising an electronic control unit as described above.

### BRIEF DESCRIPTION OF THE DRAWINGS

Further features and advantages of aspects of the invention will become more clearly apparent upon reading the following description. This description is purely illustrative and should be read in conjunction with the appended drawings, in which:

FIG. 1 schematically illustrates one embodiment of the vehicle according to the invention;

FIG. 2 schematically illustrates one embodiment of the method according to the invention.

### DETAILED DESCRIPTION OF THE PREFERRED EMBODIMENTS

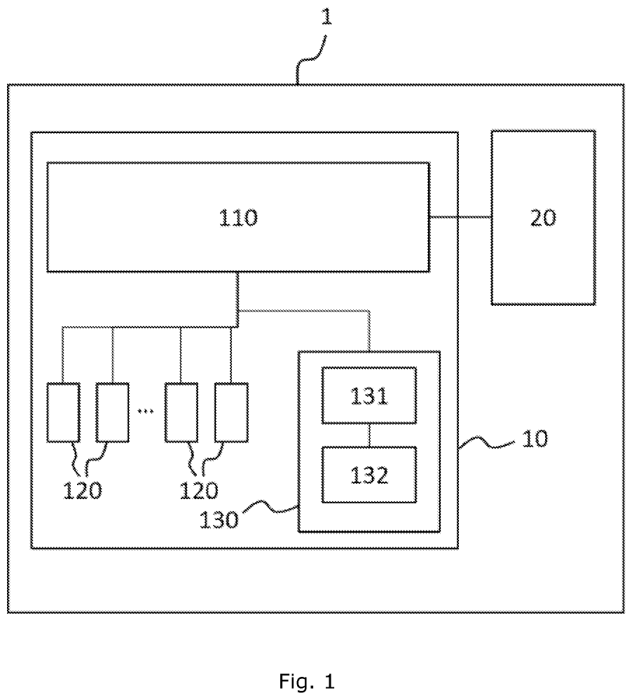

FIG. 1 shows a motor vehicle 1 according to an aspect of the invention. The vehicle 1 comprises an electronic control unit 10 for controlling elements 20 of the vehicle 1, such as, for example, an engine, electrical equipment or electronic equipment.

The electronic control unit 10 comprises a microcontroller 110, a plurality of hardware registers 120 and a memory area 130.

The microcontroller 110 is configured to receive, from an external software maintenance tool, a request to update an application installed in the space of the memory area 130 with a target application. In other words, the target application corresponds to the updated version of the installed application (or to a later version of the installed application).

The microcontroller 110 is configured to execute instructions contained in a bootloader module 131 of the memory area 130 and instructions of an application contained in a space 132 of the memory area 130.

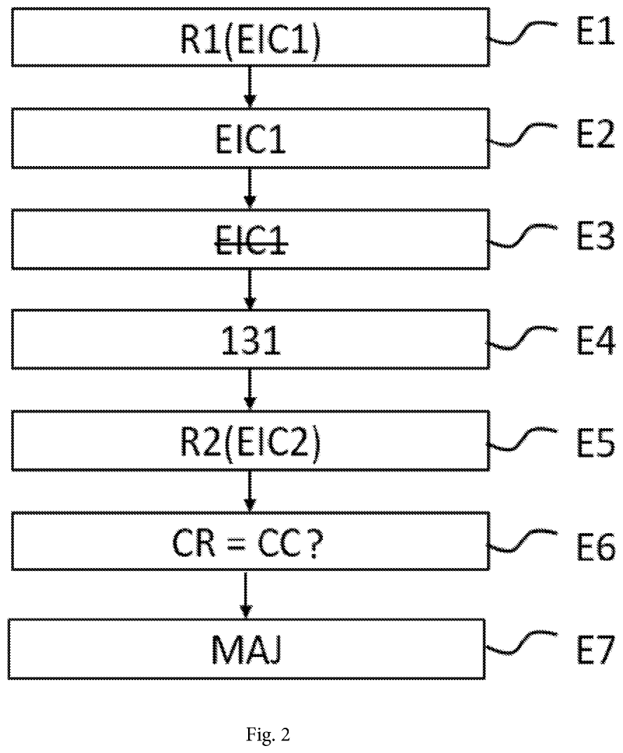

The hardware registers 120 are adapted to be placed in various positions defining the current hardware configuration CC (FIG. 2) of the electronic control unit 10. The hardware registers are memories (physically, they are D flip-flops), which retain a value (also called position) after being configured. These registers are used to configure the microcontroller, and therefore the electronic control unit. As these hardware registers 120 are known per se, they will not be described in further detail herein.

The bootloader module 131 is configured to receive update requests, for example, via the microcontroller 110. Each update request comprises a set of instructions for carrying out several functions and which is configured to be implemented with the current hardware configuration CC of the electronic control unit 10.

A first set of control instructions EIC1 (FIG. 2) allows the current hardware configuration CC of the electronic control unit 10 to be modified, i.e., the hardware registers 120, so that said current hardware configuration CC is identical to the requested hardware configuration CR for installing the application update. To this end, the first set of control instructions EIC1 preferably comprises a library of commands for modifying the hardware registers 120.

A second set of control instructions EIC2 allows the target application to be installed, i.e., the updated version of the installed application.

The microcontroller 110 is configured to implement the first set of control instructions EIC1 in order to modify the hardware registers 120 so that the current hardware configuration CC of the electronic control unit 10 is identical to the requested configuration CR for subsequently installing the updated application.

The microcontroller 110 is configured to invalidate the first set of control instructions EIC1 so that said first set of control instructions EIC1 is not subsequently re-implemented by the bootloader module 131 after it is reset, thus allowing the second set of control instructions EIC2 to be implemented for installing the application update.

The microcontroller 110 is configured to reset the bootloader module 131.

The microcontroller 110 is configured to control the bootloader module 131 so that said bootloader module 131 checks the hardware configuration CR requested by the application update.

The microcontroller 110 is configured to control the bootloader module 131 so that said bootloader module 131 installs the application update when the hardware configuration CR requested by the application update is identical to the current hardware configuration CC of the electronic control unit 10.

Firstly, an operator connects to the electronic control unit 10 via an external software maintenance tool, for example, installed on a computer, and sends a first update request R1 to the bootloader module 131, which is received by the bootloader module 131 in a step E1. This first update request R1 comprises a first set of control instructions EIC1 allowing the current hardware configuration CC of the electronic control unit 10 to be modified so that said current hardware configuration CC is identical to the requested configuration CR in order to be able to install the application update.

The microcontroller 110 then commands the bootloader module 131 so that said bootloader module 131 firstly checks that the hardware configuration CR requested by implementing the first set of control instructions EIC1 is identical to the current hardware configuration CC of the hardware registers 120 of the electronic control unit 10.

When the hardware configuration has been corrected, the microcontroller 110 commands the bootloader module 131 so that said bootloader module 131 implements the first set of control instructions EIC1 in a step E2.

Upon execution of the first set of control instructions EIC1, the hardware registers 120 of the electronic control unit 10 are modified so that the current hardware configuration CC of the electronic control unit 10 becomes identical to the requested hardware configuration CR for installing the application update.

Once the first set of control instructions EIC1 has been executed by the bootloader module 131, the microcontroller 110 then commands the bootloader module 131 so that said bootloader module 131 invalidates the first set of control instructions EIC1 in a step E3.

The microcontroller 110 then commands the bootloader module 131 so as to reset it, i.e., to relaunch the boot, in a step E4.

The operator then sends a second update request R2 to the bootloader module 131, which request is received by the bootloader module 131 in a step E5. This second update request R2 comprises a second set of control instructions EIC2, the implementation of which requires the requested hardware configuration CR newly configured by the first request R1.

The bootloader module 131 then checks that the requested hardware configuration CR, by implementing the second set of control instructions EIC2, is identical to the current hardware configuration CC of the electronic control unit 10 in a step E6, and then implements the second set of control instructions EIC2 in order to install the application update MAJ in a step E7.

Advantageously, an aspect of the invention allows the current hardware configuration CC of the electronic control unit 10 to be corrected in order to be able to install the application update and thus avoid having to change the electronic control unit 10.

1. A method for managing a memory area of an electronic control unit of a motor vehicle, said electronic control unit comprising a microcontroller, a plurality of hardware registers and a memory area, said microcontroller being configured to receive, from an external software maintenance tool, a request to update an application installed in a space of the memory area with a target application and to execute the instructions contained in a bootloader module implemented by said microcontroller and the instructions of the application contained in the space of the memory area, with the hardware registers being adapted to be placed in various positions defining the current hardware configuration of the electronic control unit, said method comprising:
receiving a first request for updating the installed application from a first set of control instructions, with said first set of control instructions being configured to be implemented with the current hardware configuration of the electronic control unit;
implementing the first set of control instructions by the bootloader module following the reception of said first request, with the first set of control instructions being configured to modify the current hardware configuration of the electronic control unit so as to make it identical to the requested hardware configuration for installing the update of the installed application;
invalidating the first set of control instructions;
resetting the bootloader module;
receiving a second request for updating the installed application from a second set of control instructions, with said second set of control instructions being configured to be implemented with the modified hardware configuration of the electronic control unit; and
implementing the second set of control instructions by the bootloader module following the reception of said second request, with the second set of control instructions being configured to check that the hardware configuration requested by the application update is identical to the modified hardware configuration of the electronic control unit and to validate the update of the application in order to implement it during the next boot.

2. The method as claimed in claim 1, wherein, with the first set of control instructions comprising a command library configured to modify the hardware registers, said library is implemented when the first set of control instructions is executed.

3. The method as claimed in claim 1, wherein, with the second set of control instructions allowing the first set of control instructions to be deleted, the method comprises a step of deleting the first set of control instructions.

4. The method as claimed in claim 1, wherein invalidating the first set of control instructions involves reactivating the bootloader module so that said bootloader module completes the update of the application.

5. A non-transitory computer program product, comprising a set of program code instructions that, when executed by one or more processors, configure the one or more processors to implement a method as claimed in claim 1.

6. An electronic control unit for a motor vehicle, said electronic control unit comprising a microcontroller, a plurality of hardware registers and a memory area, said microcontroller being configured to receive, from an external software maintenance tool, a request to update an application installed in a space of the memory area with a target application and to execute the instructions contained in a bootloader module implemented by said microcontroller and the instructions of the application contained in the space of the memory area, with the hardware registers being adapted to be placed in various positions defining the current hardware configuration of the electronic control unit, the electronic control unit being configured for:
receiving a first request for updating the installed application from a first set of control instructions, with said first set of control instructions being configured to be implemented with the current hardware configuration of the electronic control unit;
implementing the first set of control instructions by the bootloader module following the reception of said first request, with the first set of control instructions being configured to modify the current hardware configuration of the electronic control unit so as to make it identical to the requested hardware configuration for installing the update of the installed application;
invalidating the first set of control instructions;
resetting the bootloader module;
receiving a second request for updating the installed application from a second set of control instructions, with said second set of control instructions being configured to be implemented with the modified hardware configuration of the electronic control unit; and
implementing the second set of control instructions by the bootloader module following the reception of said second request, with the second set of control instructions being configured to check that the hardware configuration requested by the application update is identical to the modified hardware configuration of the electronic control unit and to validate the update of the application in order to implement it during the next boot.

7. The electronic control unit as claimed claim 6, wherein, with the first set of control instructions further comprising a library of commands configured to modify the hardware registers, the microcontroller is configured to implement said library when executing the first set of control instructions.

8. The electronic control unit as claimed in claim 6, wherein, with the second set of control instructions allowing the first set of control instructions to be deleted, the microcontroller is configured to control the deletion of the first set of control instructions.

9. The electronic control unit as claimed in claim 6, wherein the microcontroller is configured to invalidate the first set of control instructions by reactivating the bootloader module so that said bootloader module completes the update of the application.

10. A motor vehicle comprising an electronic control unit as claimed in claim 6.
